(19) United States
(12) Patent Application Publication
(10) Pub. No.: US 2023/0202278 A1
(43) Pub. Date: Jun. 29, 2023

(54) Protective Vehicle Tarpaulin System and Method

(71) Applicant: Cesar Augusto Berrios Salas, Fort Lauderdale, FL (US)

(72) Inventor: Cesar Augusto Berrios Salas, Fort Lauderdale, FL (US)

(21) Appl. No.: 17/560,339

(22) Filed: Dec. 23, 2021

(51) Int. Cl. B60J 11/04

(52) U.S. Cl. CPC B60J 11/04

(57) ABSTRACT

A system and method employing a tarpaulin may prevent or minimize moisture intrusion and debris damage from below a protected vehicle as well as from above. By way of example, a method is disclosed comprising placing a tarpaulin in a location to accommodate a vehicle to be protected in a parked state; parking the vehicle on a surface of the tarpaulin; gathering up the tarpaulin at the front, back, and sides of the vehicle; and securing peripheral edges of the tarpaulin at a height above an expected water level resulting from a flood event.

### FIELD OF THE DISCLOSURE

Aspects of the disclosed subject matter relate generally to tarpaulins for protecting vehicles, and more particularly to a system and method employing a tarpaulin or similar substrate to prevent or to minimize moisture intrusion and debris damage from below a protected vehicle as well as from above.

### BACKGROUND

Conventional vehicle pads or covers are applied to (or over top of) stationary vehicles to protect those vehicles from damage while not in use. A typical protective pad or cover may include a sheet of canvass, plastic, linen, vinyl, or other material, a fitted cover or sheath that is sized and dimensioned for a particular model of vehicle, or other lightweight or generally portable layer designed and operative to be placed between the vehicle and the exterior elements that may damage the vehicle. Irrespective of the particular implementations or design nuances, conventional vehicle covers all operate under the same principle—they are secured over the top (whether they are lain upon the surface or supported slightly above the surface) of a parked car or other vehicle, the purpose being to protect the vehicle's structure, paint finish, glass components, and the like from damage to which it otherwise might be susceptible without such a cover.

While traditional vehicle covers may be effective, to varying degrees, in preventing or minimizing damage to various vehicle components due to, for example, rain, hail, ice, falling or wind-blown debris, ultraviolet rays, and the like from above, the purpose and design of these conventional solutions do not take into consideration infiltration of flood or rain water (or of water-borne debris or other contaminants) from below, and therefore do not provide protection in that regard.

Every year, many vehicles in storm-prone areas are flooded as a result of heavy, sustained rains, flash floods, hurricane or tropical storm surges, and the like, and many vehicle owners residing near waterways must monitor weather trends upstream to determine when to move vehicles to high ground away from flood-prone riverbanks or streams. When flood waters reach the floorboards of a vehicle, water intrusion may damage critical electronic components as well as the engine, transmission, and other mechanical components, and may soak carpeting or other fabrics, leading to mold or mildew problems that are extremely difficult to remediate. Additionally, such flood waters often carry water-borne debris (e.g., abrasive dirt or mud, sticks and other plant matter, lawn ornaments, light tools or landscaping items, and the like) that can damage paint, dent body panels, scratch glass, and cause other damage if such debris is introduced under a conventional vehicle cover that is neither designed nor operative to prevent intrusion from below the vehicle.

Therefore, there is a need for an improved system and method employing a tarpaulin to prevent or to minimize moisture intrusion and debris damage from below a protected vehicle as well as from above.

### SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the disclosed subject matter in a simplified form as a prelude to the more detailed description that is presented later.

The present disclosure describes a system and method employing a tarpaulin or similar substrate to prevent or to minimize moisture intrusion and debris damage from below a protected vehicle as well as from above. In some implementations, a tarpaulin may be placed in a location intended to accommodate a vehicle in a parked (i.e., immobile) state while the vehicle is not in use; a vehicle to be protected may then be driven onto a surface of the tarpaulin and parked; the tarpaulin may then be gathered up around the front, back, and sides of the vehicle, with opposing ends or sides of the tarpaulin secured over the top of the vehicle to be protected in a manner such as described below. In the foregoing manner, the vehicle may be simultaneously protected from falling or wind-borne debris from above, on the one hand, as well as from rising waters and water-borne debris from below, on the other hand.

In accordance with one aspect of the disclosed subject matter, for example, a vehicle protection system may generally comprise: a tarpaulin to be placed in a location to accommodate a vehicle to be protected in a parked state, wherein, when the vehicle is parked on a surface of the tarpaulin, peripheral edges of the tarpaulin are gathered up over the top of the vehicle; and a fastener to secure the peripheral edges at a height above an expected water level resulting from a flood event.

Vehicle protection systems are disclosed wherein the tarpaulin is water-resistant, wherein the tarpaulin comprises a water-resistant layer (comprising one of polyurethane, rubber, vinyl, or plastic), or both.

Vehicle protection systems are disclosed wherein the tarpaulin is impact-resistant, wherein the tarpaulin comprises an impact-resistant layer (comprising one of Kevlar™ or carbon fiber), or both.

Additionally or alternatively, vehicle protection systems are disclosed wherein the fastener comprises a plurality of fastening elements (such as buttons, snaps, hook and loop fasteners, grommets, eyelets, and strings, and the like).

A vehicle protection system as set forth below may comprise an additional cover overlaid atop the vehicle and the tarpaulin, wherein the additional cover spans an area at which the peripheral edges of the tarpaulin meet over the top of the vehicle. In some implementations, the additional cover comprises a water-resistant layer, an impact-resistant layer, or both.

In some vehicle protection systems, the tarpaulin further comprises a reinforced portion positioned and dimensioned to engage a wheel of the vehicle when the vehicle is parked. The vehicle may be powered or self-propelled, or may be unpowered or towed, for example.

In accordance with another aspect of the disclosed subject matter, a method of protecting a vehicle may generally comprise: placing a tarpaulin in a location to accommodate a vehicle to be protected in a parked state; parking the vehicle on a surface of the tarpaulin; gathering up the tarpaulin at the front, back, and sides of the vehicle; and securing peripheral edges of the tarpaulin, wherein the securing comprises retaining the peripheral edges of the tarpaulin at a height above an expected water level resulting from a flood event.

Methods are disclosed wherein the parking comprises selectively aligning the vehicle on the tarpaulin, and wherein the selectively aligning comprises selectively aligning the vehicle with a reinforced portion of the tarpaulin. In some methods, the retaining comprises utilizing a fastening element such as set forth below.

Methods are disclosed further comprising providing an additional cover over the tarpaulin such that the additional cover spans an area at which the peripheral edges of the tarpaulin are secured. Additionally or alternatively, a method may further comprise anchoring the tarpaulin to resist movement of the vehicle.

In that regard, methods are disclosed wherein the anchoring comprises utilizing a tie-down cable attached to the tarpaulin, wherein the anchoring comprises utilizing a tie-down cable extending over the vehicle and the tarpaulin, or both.

The foregoing and other aspects of various disclosed embodiments will be apparent through examination of the following detailed description thereof in conjunction with the accompanying drawing figures, in which like reference numerals are used to represent like components throughout, unless otherwise noted.

### DESCRIPTION OF THE DRAWING FIGURES

FIG. 1 is a top view of a vehicle disposed on a surface of one embodiment of a tarpaulin;

FIG. 2 is a top view of the vehicle and tarpaulin of FIG. 1 with opposing sides of the tarpaulin gathered over the top of the vehicle;

FIG. 3 is a top view of the vehicle and tarpaulin of FIGS. 1 and 2 with opposing ends of the tarpaulin gathered over the top of the vehicle;

FIGS. 4A and 4B are top views of alternative embodiments of a tarpaulin;

FIG. 5 is a side view of the vehicle and tarpaulin of FIG. 3 with an additional protective cover applied;

FIG. 6 is a side view of the vehicle and tarpaulin of FIG. 5 illustrated with optional anchors; and

FIG. 7 is a flow diagram illustrating aspects of one embodiment of a method of protecting a vehicle.

### DETAILED DESCRIPTION

Certain aspects and features of the disclosed subject matter may be further understood with reference to the following description and the appended drawing figures. In operation, a system and method of protecting a vehicle may employ a tarpaulin from the bottom, rather than (or, optionally, in cooperation with) a protective layer that is applied to the top of the vehicle to be protected. Those of skill in the art will appreciate that the approach set forth below may prevent or minimize water and debris intrusion from beneath the protected vehicle, which may in turn prevent or minimize cosmetic, mechanical, electrical, and other damage in a manner not addressed by traditional car cover solutions.

In the context of the present disclosure, it is noted that the term “tarpaulin” is intended to mean a sheet of material or substrate to be employed to protect a vehicle from damage due to debris, inclement weather and atmospheric conditions, ultraviolet radiation, and the like. Those of skill in the art of vehicle protection will readily appreciate that a tarpaulin as illustrated and described may be a sheet of fabric, cloth, or other material such as canvas, linen, polyester, nylon, vinyl, rubber, plastics such as polyethylene, or a combination of these or other suitable materials to provide the operational characteristics set forth below. In some instances, fibrous materials such as Kevlar™ or carbon fibers may be used for or interwoven into the structure of the tarpaulin to add strength or impact resistance.

In some implementations, a tarpaulin as described herein may be made of or comprise water-resistant or waterproof material; in the case where the tarpaulin is mainly fabricated of fabric or cloth such as canvas or linen, for example, the tarpaulin may be coated or impregnated with a water-resistant or waterproof material such as polyurethane, rubber, vinyl, or other suitable hydrophobic material or compound. In that regard, the tarpaulin need not be a single layer of material, and may benefit in some applications from use of a soft, scratch-resistant layer (such as canvas, felt, or linen) on an interior surface making contact with a vehicle to be protected, on the one hand, and a waterproof and/or ultraviolet resistant layer (such as vinyl or polyethylene), an impact resistant layer (such as Kevlar), or both, exposed to the exterior environment, on the other hand. The present disclosure is not intended to be limited by the nature of the materials used to construct the tarpaulin, though it is noted that water-resistance and impact resistance are both desirable qualities as will be appreciated from the description below.

Additionally, it is noted that the term “vehicle” is intended to be broad enough to encompass cars, trucks, vans, carts, utility vehicles, motorcycles and scooters, all-terrain vehicles, electric and gas driven wagons and buggies, and the like. While many vehicle owners may only desire to use a vehicle protection system in conjunction with their most valuable or prized vehicles, the present application is not intended to be so limited, though it is noted that it may be desirable to provide a tarpaulin having a size and appropriate dimensions that are suitable for the type of vehicle to be protected. In that regard, it is contemplated that commercial embodiments of the disclosed vehicle protection system may be custom fit to a specific model of vehicle from a specific manufacturer.

Further, it is also noted that a system and method as set forth herein may also have utility in providing protection for a variety of types of equipment, appliances, and electronic devices. In that regard, generators, pumps, air compressors, and other electrical, mechanical, and electromechanical or electronic apparatus or equipment may also benefit from the disclosed system and method, though it is noted that such apparatus or equipment may generally be characterized as portable, movable, or capable of being relocated (i.e., disposed on or set upon a tarpaulin as set forth herein), which may or may not include apparatus or equipment having integrated wheels. Specifically, the term “vehicle” in this context does not necessarily imply or require that a vehicle is internally powered or otherwise self-propelled. In this context, examples of “vehicles” include, without limitation, unpowered or towed platforms or trailers, wagons, carts, or skis that support generators, pumps, compressors, condensers, electrified or electronic road signs or billboards, or other apparatus or equipment borne by such unpowered platforms and that would benefit from protection from water and debris intrusion from below as set forth herein.

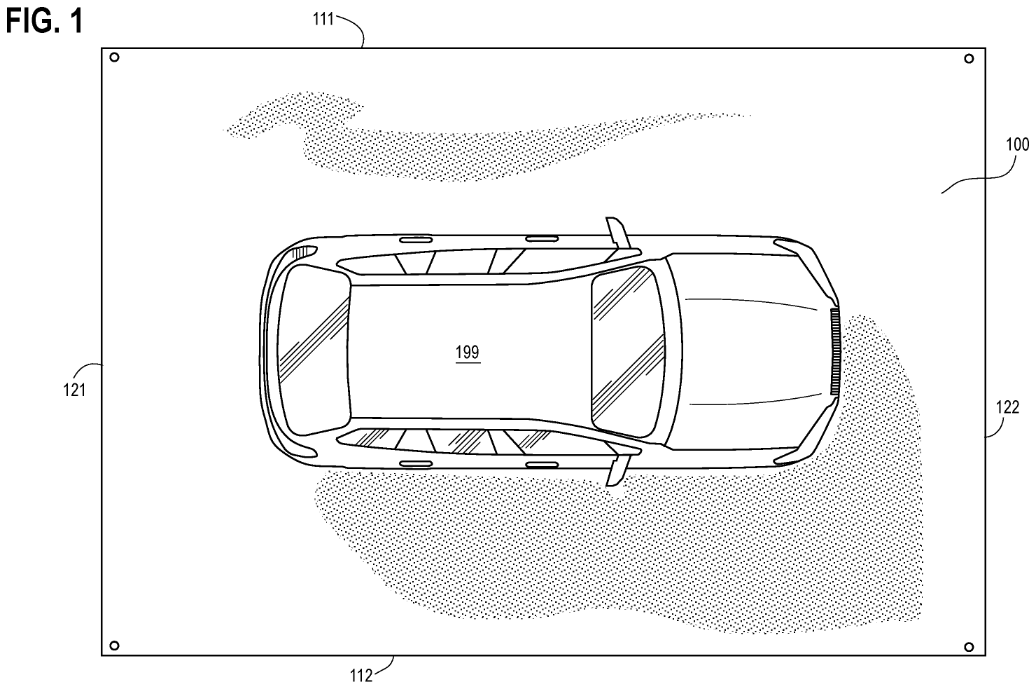

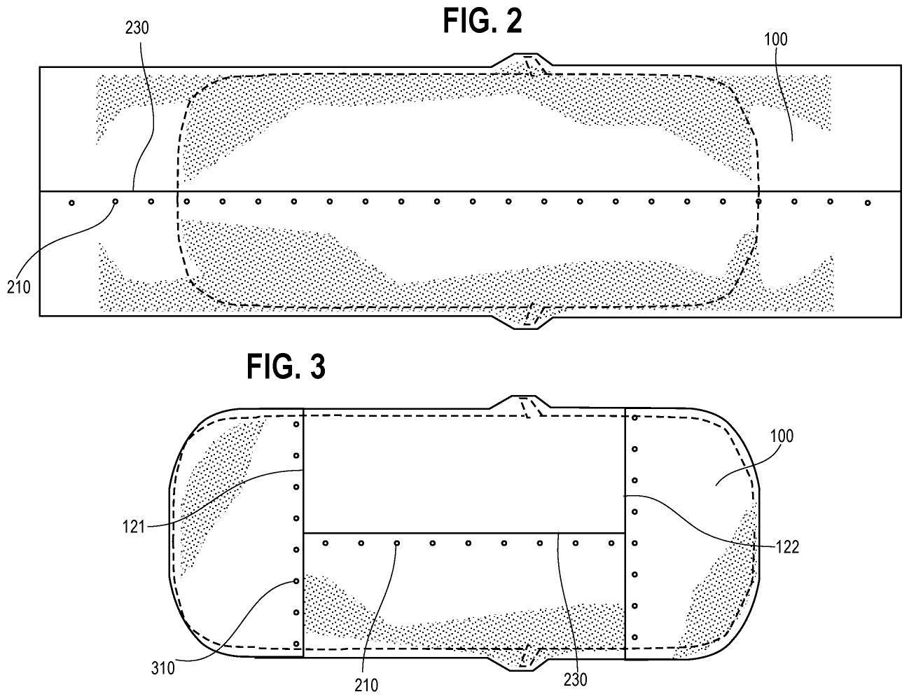

Turning now to the drawing figures, FIG. 1 is a top view of a vehicle disposed on a surface of one embodiment of a tarpaulin, FIG. 2 is a top view of the vehicle and tarpaulin of FIG. 1 with opposing sides of the tarpaulin gathered over the top of the vehicle, and FIG. 3 is a top view of the vehicle and tarpaulin of FIGS. 1 and 2 with opposing ends of the tarpaulin gathered over the top of the vehicle.

As indicated in FIG. 1, implementations of a vehicle protection system may generally comprise a tarpaulin 100 having opposing back and front ends (reference numerals 121 and 122, respectively) and opposing left and right sides (reference numerals 111 and 112, respectively). In this context, it will be appreciated that the terms “left,” “right,” “front,” and “back” are relative (provided only by way of simplifying the following description), and may change with a selected orientation of vehicle 199 parked on tarpaulin 100.

By way of additional definition, it is noted that the “bottom” or “under” side of vehicle 199 is intended to mean that portion of vehicle 199 that faces or is otherwise exposed to the ground, a road, a garage floor, or other surface upon which vehicle 199 may sit while parked when not in use. Conversely, the “top” of vehicle 199 is intended to mean that portion or those portions of vehicle 199 (such as the hood, trunk, roof, front and back wind screens, etc.) that are substantially opposite the “bottom” and that are substantially exposed to falling or wind-blown rain, hail, and debris. Those of skill in the art will readily appreciate that references to gathering, folding, pulling, or collecting portions of tarpaulin 100 “over the top” of vehicle 199 are generally intended to mean extending portions of tarpaulin 100 from a direction of the “bottom” of vehicle 199 in the direction of components (such as the hood, trunk, roof, front and back wind screens, etc.) of vehicle 199 that are not on the “bottom.” In this context, therefore, it will be appreciated that a hood and a trunk lid of a typical sedan may still be considered the “top” of such an example vehicle 199, even though they are not at the highest point of the structure, when viewed in any elevation view.

As set forth herein, tarpaulin 100 may be characterized as a protective sheet or substrate having structural qualities substantially as described above, and may be constructed of or comprise cloth (such as linen, canvas, felt, cotton, or other textile materials), synthetic fabrics or layers (such as nylon, polyester, vinyl, and the like), or other engineered fibrous materials or layers (such as Kevlar™ or carbon fibers). Rubber, polyethylene or other plastics, and other water-resistant or water proof materials may be layered in or on or otherwise incorporated into a structure of tarpaulin 100 as is generally known in the art. As set forth in more detail below, it may generally be desirable that tarpaulin 100 is implemented to be ruggedized (or “tough”) enough to withstand being driven over by vehicle 199 and to resist impacts from falling, wind-blown, and water-borne debris during periods of inclement weather, flexible or pliant enough to be folded (or “gathered up”) over the top of vehicle 199 when vehicle 199 is not in use, and sufficiently water-resistant or waterproof to prevent or delay intrusion of water from under vehicle 199 during periods of storm surge or flooding conditions.

During use of a vehicle protection system (i.e., at times when vehicle 199 itself is not in use), sides 111 and 112 of tarpaulin 100 may be gathered up or folded up over the top of vehicle 199 substantially as illustrated in FIG. 2; similarly, back 121 and front 122 of tarpaulin 100 may be gathered or folded up over the top of vehicle 199 substantially as illustrated in FIG. 3. Additional solutions are also contemplated, as set forth below.

FIG. 2 illustrates a state in which left side 111 and right side 112 of tarpaulin 100 (see FIG. 1) have been folded up, drawn up, gathered up, or otherwise disposed on top of vehicle 199 (obviously, in this case, from opposite sides of vehicle 199), and have been caused to meet at seam 230. A fastening element or, more practically, a series of fastening elements, to secure sides 111 and 112 in position above a surface (such as hood, roof, trunk lid, windscreens, etc.) of vehicle 199 is illustrated in FIG. 2 (at reference numeral 210) by way of example.

By design, fastening elements 210 may be implemented as grommets and opposing strings or clasps, for example, or as snaps, opposing buttons and button holes, hook and loop fasteners, or any other fastening mechanisms or cooperative structures generally known in the art or developed in accordance with known principals. As will be appreciated, it may be desirable to manufacture, construct, or otherwise to fabricate the opposing and cooperating structures of fastening elements 210 of silicon, rubber, plastic, fabric, or other relatively soft or non-abrasive materials that are configured and operative not to scratch, mar, or otherwise damage a surface finish or glass, metal, or other structural components of vehicle 199.

In some implementations, it may be desirable to construct fastening elements 210 as grommets or eyelets disposed on one side (say, left side 111) of tarpaulin 100 and cooperating ropes or cables to be threaded through the grommets disposed on the opposite side (say, right side 112) of tarpaulin 100. In this arrangement, perfect placement of vehicle 199 on top of tarpaulin 100 may not be necessary during use of the vehicle protection system, as any variations in the manner in which left and right sides 111 and 112 overlap at seam 230 may be accommodated by appropriately dimensioned ropes or cables associated with fastening elements 210. Alternatively, enough “slack” or excess material may be used in the structure of tarpaulin 100, itself, to ensure that opposing structures of fastening elements 210 may be properly aligned and engaged to secure sides 111 and 112 at seam 230, even in the event that vehicle 199 is parked askew or otherwise in a sub-optimal manner on tarpaulin 100.

FIG. 3 illustrates a state in which back end 121 and front end 122 of tarpaulin 100 (see FIG. 1) have been folded up, drawn up, gathered up, or otherwise disposed on top of vehicle 199 from a rear end and a front end, respectively. As with the folding or gathering event illustrated in FIG. 2, a fastening element or, more practically, a series of fastening elements, to secure ends 121 and 122 in position above a surface of vehicle 199 is illustrated in FIG. 3 (at reference numeral 310) by way of example. In this case, fastening elements 310 may be designed and operative to secure back end 121 and front end 122, respectively, of tarpaulin 100 to portions of left and right sides 111 and 112.

Fastening elements 310 may be implemented as hook and loop fasteners or any of the other fastening mechanisms or cooperative structures described above with reference to fastening elements 210 illustrated in FIG. 2. As noted above, irrespective of the specific structures employed, it may be desirable that fastening elements 310 are embodied in or comprise non-abrasive materials so as not to scratch, mar, or otherwise damage a surface finish or glass, metal, or other structural components of vehicle 199.

It is worth noting with reference to FIGS. 1 through 3 that rotating vehicle 199 by 90 degrees, for instance, may change the definitions of the terms “left,” “right,” “front,” and “back” as used above (from the perspective of a viewer looking down from a “top” of vehicle 199), but the same effect may be achieved, in any event. Further, it will be appreciated that the order of operations depicted in FIGS. 2 and 3 may be reversed without altering the beneficial effects of the disclosed vehicle protection system. For instance, front and back ends 122 and 121 of tarpaulin 100 may be folded up before left and right sides 111 and 112 in some cases, which may be determined or influenced by the placement or orientation of fastening elements 210 and 310, for instance, the size and dimensions of tarpaulin 100, or a combination of these and a variety of other factors.

In that regard, it will be appreciated that FIGS. 2 and 3 are provided by way of example only, and not by way of limitation, and that other methods of folding, gathering, or collecting portions of tarpaulin 100 over the top of vehicle 199 will be readily apparent to those of skill in the art. For instance, either of fastening elements 210 and 310, or both, may be omitted or may be optional in some implementations, depending upon the size and dimensions of tarpaulin 100 relative to vehicle 199, the manner in which the peripheral edges (such as back 121, front 122, left 111, and right 112) of tarpaulin 100 are to be secured over top of vehicle 199, or a combination of these and other factors. For example, if tarpaulin 100 is sufficiently sized relative to a footprint and exterior dimensions of vehicle 199, sides 111 and 112, back 121, and front 122 of tarpaulin 100 may simply be bunched or gathered over the roof (or trunk lid, or hood, etc.) of vehicle 199 and secured with a loop of rope or cable, a clamp or vice, or some other mechanism for crimping, clamping, tying off, or otherwise securing together a mass of opposing fabric, sheet, or substrate ends as is generally known in the art. A rope with a slip knot, for instance, may be suitable for this purpose of tying off edges of tarpaulin 100, as may be a vice grip, plastic cable or “Zip”TM ties, or other crimping or claiming mechanisms having components constructed of materials that will not damage a surface of vehicle 199.

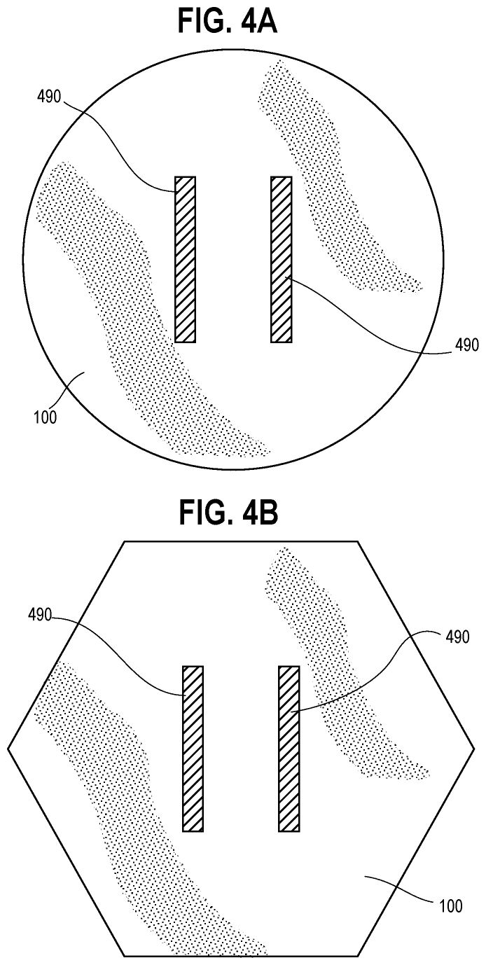

Such mechanisms for crimping, clamping, tying off, or otherwise securing together a mass of opposing fabric, sheet, or substrate ends (such as the peripheral sides and ends of tarpaulin 100) may have particular utility in situations in which tarpaulin 100 is not specifically rectangular in plan as illustrated in FIG. 1. In that regard, FIGS. 4A and 4B are top views of alternative embodiments of a tarpaulin. Specifically, tarpaulin 100 is illustrated, in one case, as being round (FIG. 4A), and, in another case, as being hexagonal (FIG. 4B), in plan view (i.e., from a perspective looking down from above). In these arrangements illustrated in FIGS. 4A and 4B, fastening elements such as 210 and 310 may be provided in some instances, but it may also be the case that tarpaulin 100 may not comprise or incorporate any such fastening elements, particularly in situations in which opposing peripheral sides or edges of tarpaulin 100 may not meet in a predictable manner upon being folded up or gathered up on top of vehicle 199. Accordingly, it may be desirable that peripheral edges or sides of tarpaulin 100 are folded up, drawn up, gathered up, or otherwise disposed on top of vehicle 199 and simply tied off or otherwise crimped without the aid of fastening elements 210 or 310, as will be appreciated by those of skill in the art.

Also of note in FIGS. 4A and 4B are the depicted treads 490, which may be integrated with, attached to, disposed upon, or otherwise engaged with a surface of tarpaulin 100 that is facing the bottom of vehicle 199. In that regard, and as noted above, tarpaulin 100 may be designed and operative to accommodate a vehicle 199 that is parked atop an upward-facing surface of tarpaulin 100—i.e., tarpaulin 100 may be disposed, lain, situated, located, or provided upon a surface (such as the ground, a road, a tarmac, a garage floor, etc.) upon which vehicle 199 may be parked or stored when not in use. Subsequently, vehicle 199 may be driven onto, and parked upon, an upward facing surface of tarpaulin 100. It may be desirable that wheels of vehicle 199 ride up onto treads 490, and remain there during use of tarpaulin 100 and the associated vehicle protection system.

Treads 490 illustrated in FIGS. 4A and 4B may beneficially be placed a distance apart that approximates a distance between the wheels (i.e., the “track”) of an applicable vehicle 199 for which tarpaulin 100 has been designed. Treads 490 may engage tires of vehicle 199 to prevent slipping, to provide additional structural integrity or resistance to wear for tarpaulin 100 or otherwise to extend its useful life—e.g., to prevent fraying, tearing, or shredding of tarpaulin 100, or to prevent or to minimize undue wear to the surface of tarpaulin 100 engaged by wheels of vehicle 199.

Treads 490 may be applied to, attached to, disposed upon, or otherwise made a part of a surface of tarpaulin 100 that faces the bottom of vehicle 199 when tarpaulin 100 is lain upon a parking surface; additionally or alternatively, treads 490 may be integrated with a structure of tarpaulin 100 such that treads 490 extend all the way through such structure—i.e., treads 490 may make contact both with a parking surface, on a bottom surface, and the wheels of vehicle 199, on a top surface, of tarpaulin 100 (a cross-section of tarpaulin 100 depicted in FIGS. 4A and 4B illustrating this option has been omitted for brevity). Treads 490 may be integrated with a structure of tarpaulin 100, or they may be attached or adhered (such as by stitching, adhesives, hook and loop fasteners, snaps or other pressure-activated fittings, or the like) thereto, depending upon cost considerations, materials used for tarpaulin 100, treads 490, or both, the size and nature of tarpaulin 100 as compared to vehicle 199 (and, in particular, its wheelbase and track), whether tarpaulin 100 is custom fit or generic, or a combination of these and a variety of other factors.

It will be readily apparent from review of FIGS. 1, 4A, and 4B, that the present disclosure is not intended to be limited by any particular shape of tarpaulin 100 or by the size, shape, or relative orientation of treads 490 (though in most instances, it is noted, that treads 490 will generally be parallel with each other when tarpaulin 100 is lain flat on a parking surface).

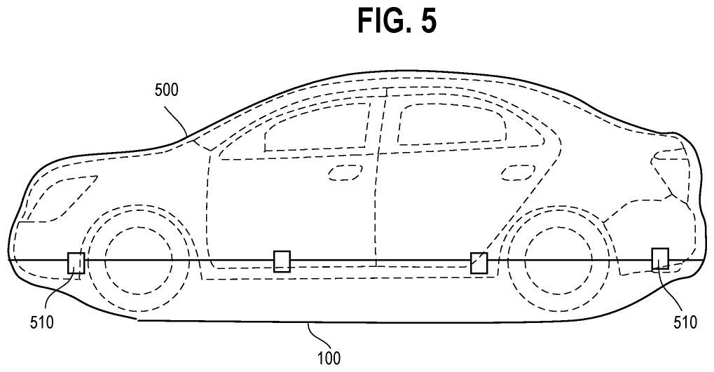

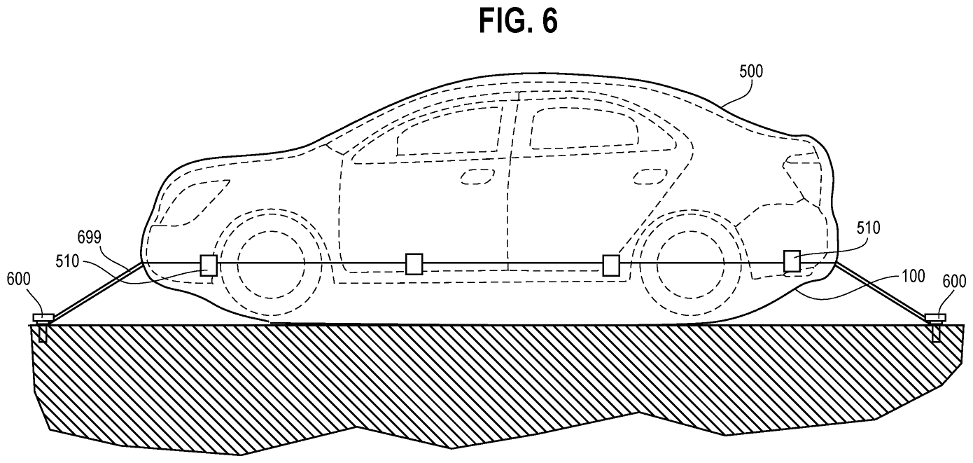

FIG. 5 is a side view of the vehicle and tarpaulin of FIG. 3 (or of FIGS. 4A or 4B) with an additional protective cover applied. As illustrated in FIG. 5, an additional cover 500 may be placed over, disposed on, or otherwise secured to tarpaulin 100 that has been fastened to vehicle 199 substantially as set forth above.

In the FIG. 5 arrangement, additional cover 500 may be embodied in or comprise the types of materials (e.g., cloth, fabric, synthetics, fibers, plastics, etc.) described above with reference to tarpaulin 100, though, given the protective nature and operative characteristics of tarpaulin 100, almost any type of material will suffice for additional cover 500. As illustrated, additional cover 500 may be attached, coupled, or fastened to tarpaulin 100 by fastening elements 510. In this case, it may be desirable that cooperating structures of fastening elements 510 do not penetrate all the way through tarpaulin 100, as maintaining water-resistance at the level indicated by fastening elements 510 in FIG. 5 may have utility in preventing water penetration though tarpaulin 100. In that regard, press- or friction-fit buttons or snaps, or hook and loop fastener solutions, may be employed for fastening elements 510 to maintain a water-tight condition inside tarpaulin 100 (i.e., adjacent to vehicle 199). Additionally or alternatively, ropes, cables, elastic bands or “bungie” cords may be used to bias the perimeter of additional cover 500 against tarpaulin 100 as illustrated in FIG. 5.

FIG. 6 is a side view of the vehicle and tarpaulin of FIG. 5 illustrated with optional anchors. Those of skill in the art will appreciate that waterproof or water-resistant tarpaulin 100 deployed as set forth above may create buoyancy in the event of rising flood waters. To ameliorate possible consequences of vehicle 199 and tarpaulin 100 being floated by sufficiently deep waters, some implementations of a vehicle protection system may employ a tie-down cable 699 or similar device that may be attached, on the one hand, to a particular portion (e.g., a grommet or reinforced section) of tarpaulin 100 or additional cover 500, for instance, and further attached, on the other hand, to a fixed structure embedded into, attached to, or otherwise integrated with the ground or a physical structure, such as indicated by anchor 600 in FIG. 6.

Specifically, an anchor 600 (or more than one anchor 600) may secure a tie-down cable 699 (or more than one tie-down cable 699) to prevent vehicle 199 from drifting away from its parking location, even in instances where flood waters may otherwise be sufficiently deep to float vehicle 199 and to cause it to drift away. Anchor 600 may be embodied in or comprise any (or a combination of) the following, in each case being securely embedded into or fastened to the ground, a floor, or other structure: a heavy weight; a metal, cable, or fabric loop or hook; a capstan; a mainstay or other footing; a buttress, pillar, or cleat; or other structure that may be selected in accordance with the type, length, and operational characteristics of the tie-down cable 699 in connection with which it may be deployed. In that regard, tie-down cable 699 may be a wire cable (e.g., stainless steel, titanium, etc.) which may be coated to provide resistance to the elements, a nylon, other synthetic, or fabric (such as cotton or hemp) rope, or other elongate fastener. It will be appreciated that the structure, materials, and particular implementation of anchor 600 and tie-down cable 699 may be selected as a function of the size, dimensions, and weight of vehicle 199, the area in which vehicle 199 is to be restricted during emergency situations (e.g., the amount of “slack” or reach that vehicle 199 is allowed to drift and the expected depth of flood waters to be accommodated), or a combination of these and a variety of other factors.

In some instances, it may be desirable that tie-down cable 699 (or a plurality of such tie-down cables 699) is deployed over the top of vehicle 199 (and tarpaulin 100 and/or additional cover 500), without actually being attached to tarpaulin 100 or additional cover 500. In such circumstances, such a tie-down cable 699 may be draped over vehicle 199, i.e., attached only to a respective anchor 600 on opposing sides of vehicle 199. In these implementations, it may be desirable to employ a plurality of such tie-down cables 699 that cross over each other, effectively creating a web or mesh that prevents or limits undesirable movement of vehicle 199 in the event of flood conditions.

The present disclosure is not intended to be limited by any specific construction, materials, or operational characteristics of anchor 600 or tie-down cable 699, as these may be selected as a design choice, and may be application specific.

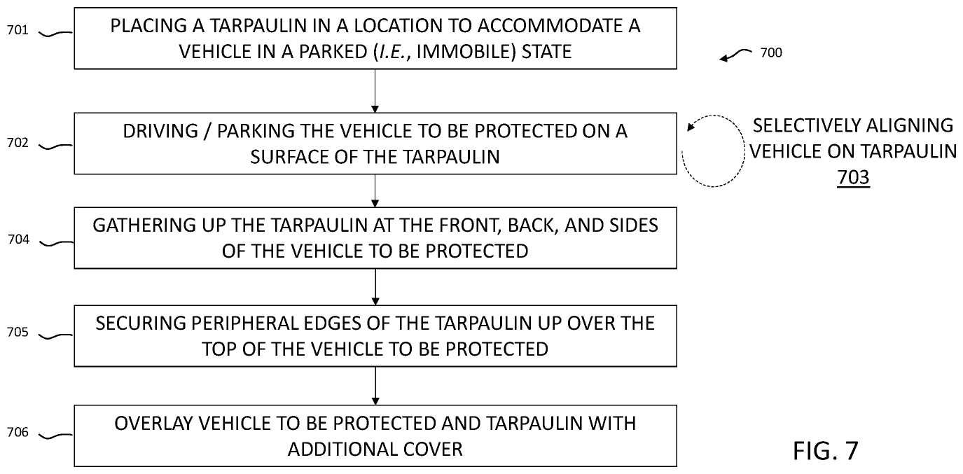

FIG. 7 is a flow diagram illustrating aspects of one embodiment of a method of protecting a vehicle. In accordance with aspects of the present disclosure, a method 700 of protecting a vehicle may generally begin with placing a tarpaulin (such as tarpaulin 100) in a location to accommodate a vehicle in a parked (i.e., immobile) state as indicated at block 701. As noted above, the disclosed system and method are intended to be operative while the vehicle to be protected (such as vehicle 199) is not in use and is parked as desired by an owner or caretaker. This may be in a garage, barn, carport, or other shelter, for instance, or in the open air on a street, driveway, parking lot or pad, or other surface, as available. In any event, the operation depicted at block 701 is intended to encompass placing, laying, or disposing a tarpaulin (such as that described above with reference to FIGS. 1 through 6) in a location where the vehicle to be protected is to remain while protected as set forth herein.

The vehicle to be protected may then be driven onto a surface of the tarpaulin and parked, as indicated at block 702. In some instances, such as described above with reference to FIGS. 4A and 4B, the operation depicted at block 702 may include selectively aligning the vehicle's wheels with reinforced portions (such as treads 490) disposed on or incorporated into a structure of the tarpaulin and parking the vehicle such that its wheels are engaged with the reinforced portions; in other instances, the operation depicted at block 702 may include selectively aligning or otherwise orienting the vehicle in a predetermined manner based upon the size and dimensions of the tarpaulin. In either event, this selective alignment operation is depicted by the dashed loop at reference numeral 703. In that regard, it is noted again that the tarpaulin to be employed may be custom fit or otherwise suitably sized and dimensioned for the vehicle to be protected, and may have treads that are spaced and dimensioned based upon a particular vehicle's track and wheelbase.

The method 700 may continue (at block 704) with gathering up the tarpaulin at the front, back, and sides of the vehicle to be protected. Some approaches to the operation depicted at block 704 are illustrated in FIGS. 2 and 3, but other options are contemplated. One aspect of this operation is to collect opposing ends (i.e., front and back) and opposing sides (i.e., left and right) of tarpaulin up over the “top” of the vehicle to be protected, meaning to lift those opposing peripheral edges of the tarpaulin to a height above the ground that will prevent rain, storm surge, or flood waters from penetrating—where the peripheral edges of the tarpaulin are gathered up “over the top” of the vehicle as described above, then flood waters would have to cover the vehicle before seeping between the tarpaulin and the vehicle. Additionally, the method 700 may continue with securing peripheral edges of the tarpaulin up over the top of the vehicle to be protected as indicated at block 705; this may further prevent or minimize intrusion of water into the space between the protective tarpaulin and the vehicle to be protected.

As set forth above, it will be appreciated that the term “peripheral edges” when used in the context of the protective tarpaulin (such as reference numeral 100), generally refers to the edge of the sheet or substrate that is deployed as set forth above with reference to FIGS. 1 through 6. Specifically, peripheral edges of the tarpaulin, in the case of FIG. 1, may be left and right sides (reference numerals 111 and 112) and front and back ends (reference numerals 122 and 121); in FIGS. 3 and 4, however, the term “peripheral edges” may refer the perimeter boundaries of tarpaulin 100 (i.e., “front,” “back,” “left,” and “right” in these cases may be application-specific and depend upon the orientation at which the vehicle to be protected is parked atop tarpaulin 100). In any event, the operation depicted at block 705 is intended to encompass securing those peripheral edges at a height above an expected waterline in a flood or storm surge condition—as described above, this height is generally over the top of the vehicle to be protected (reference numeral 199), but this need not necessarily be the case.

It is noted that the securing operation at block 705 may be effectuated via fastening elements (reference numerals 210 and 310 such as described above), a rope or cable, a clamp or crimping mechanism, or any other physical tie or clasp suitable to accommodate the mass of tarpaulin 100 and to secure it (to itself) above the water levels expected during a flood or storm event.

The method may continue with overlaying the vehicle to be protected and the protective tarpaulin with an additional cover as indicated at block 706. This operation (one implementation of which is illustrated graphically at FIGS. 5 and 6) may serve two purposes: to provide additional protection to the vehicle to be protected (such as vehicle 199) from flying or falling debris during gusty or stormy conditions; and to provide additional water proofing or water resistance by covering the area at which the peripheral edges of protective tarpaulin 100 are brought together (such as at seam 230, for instance).

Finally, in some implementations, the method 700 may conclude with anchoring the protective tarpaulin (or the vehicle) to prevent the vehicle to be protected from unwanted drifting during flooding or storm surge conditions. This operation is not shown in FIG. 7 for brevity, but is described above with reference to FIG. 6.

It is noted that the arrangement of the blocks and the order of operations depicted in FIG. 7 are not intended to exclude other alternatives or options. For example, the operations depicted at blocks 702 and 703 may be reversed in order, or they may be made to occur substantially simultaneously in some implementations. Further, the operation depicted at block 704 may occur substantially simultaneously with the operation depicted at block 705, or even with the operation depicted at block 706 in instances where it is desirable to provide additional water proofing and impact resistance as or when the protective tarpaulin is secured over the top of the vehicle to be protected.

It is also worth noting here, again, that the disclosed subject matter is not intended to be limited by the type of vehicle 199 to be protected. As noted above, cars, trucks, vans, carts, cycles, utility vehicles, and the like, may all benefit from the structures and methodologies set forth herein. In that regard, it may be desirable to size and dimension a protective tarpaulin (such as tarpaulin 100) and any reinforced portions (such as treads 490) specifically for a particular vehicle (or type of vehicle) size and shape, though that is a matter of design choice. Additionally or alternatively, an additional cover (such as additional cover 500) may be sized and dimensioned for a particular vehicle or vehicle type, while protective tarpaulin 100 may be made large enough or generic enough to be considered “one size fits all,” for example. Those of skill in the art will appreciated that various alternatives and optional features are within the scope and contemplation of the present disclosure.

In the regard, it is noted that several features and aspects of a system and method have been illustrated and described in detail with reference to particular embodiments by way of example only, and not by way of limitation. It is noted again that alternative implementations and various modifications to the disclosed embodiments are within the scope and contemplation of the present disclosure. Therefore, it is intended that the present disclosure be considered as limited only by the scope of the appended claims.

What is claimed is:

1. A vehicle protection system comprising:
a tarpaulin to be placed in a location to accommodate a vehicle to be protected in a parked state, wherein, when the vehicle is parked on a surface of the tarpaulin, peripheral edges of the tarpaulin are gathered up over the top of the vehicle; and
a fastener to secure the peripheral edges at a height above an expected water level resulting from a flood event.

2. The vehicle protection system of claim 1 wherein the tarpaulin is water-resistant.

3. The vehicle protection system of claim 2 wherein the tarpaulin comprises a water-resistant layer comprising one of polyurethane, rubber, vinyl, or plastic.

4. The vehicle protection system of claim 1 wherein the tarpaulin is impact-resistant.

5. The vehicle protection system of claim 4 wherein the tarpaulin comprises an impact-resistant layer comprising one of Kevlar™ or carbon fiber.

6. The vehicle protection system of claim 1 wherein the fastener comprises a plurality of fastening elements.

7. The vehicle protection system of claim 1 further comprising an additional cover overlaid atop the vehicle and the tarpaulin, wherein the additional cover spans an area at which the peripheral edges of the tarpaulin meet over the top of the vehicle.

8. The vehicle protection system of claim 7 wherein the additional cover comprises a water-resistant layer.

9. The vehicle protection system of claim 7 wherein the additional cover comprises an impact-resistant layer.

10. The vehicle protection system of claim 1 wherein the tarpaulin further comprises a reinforced portion positioned and dimensioned to engage a wheel of the vehicle when the vehicle is parked.

11. A method of protecting a vehicle, the method comprising:
placing a tarpaulin in a location to accommodate a vehicle to be protected in a parked state;
parking the vehicle on a surface of the tarpaulin;
gathering up the tarpaulin at the front, back, and sides of the vehicle; and
securing peripheral edges of the tarpaulin, wherein the securing comprises retaining the peripheral edges of the tarpaulin at a height above an expected water level resulting from a flood event.

12. The method of claim 11 wherein the parking comprises selectively aligning the vehicle on the tarpaulin.

13. The method of claim 12 wherein the selectively aligning comprises selectively aligning the vehicle with a reinforced portion of the tarpaulin.

14. The method of claim 11 wherein the retaining comprises utilizing a fastening element.

15. The method of claim 11 further comprising providing an additional cover over the tarpaulin such that the additional cover spans an area at which the peripheral edges of the tarpaulin are secured.

16. The method of claim 11 further comprising anchoring the tarpaulin to resist movement of the vehicle.

17. The method of claim 16 wherein the anchoring comprises utilizing a tie-down cable attached to the tarpaulin.

18. The method of claim 16 wherein the anchoring comprises utilizing a tie-down cable extending over the vehicle and the tarpaulin.
